(19) United States
(12) Patent Application Publication
(10) Pub. No.: US 2008/0308695 A1
(43) Pub. Date: Dec. 18, 2008

(54) Universal pot holder

(76) Inventor: Kevin Lambert, Minneapolis, MN (US)

Correspondence Address: Roger L. Belfay, 829 Tuscarora Avenue, Saint Paul, MN, 55102, US

(21) Appl. No.: 11/820,335

(22) Filed: Jun. 18, 2007

(51) Int. Cl. F16M 13/02

(52) U.S. Cl. 248/226.11

(57) ABSTRACT

The universal vase holder is an article for holding a vase, pot, or ornament to a supporting object. The universal vase holder comprises: a base; a brace attached to said base and extending downward from said base; a first telescoping member telescopically attached to said base; a second telescoping member telescopically attached to said base; a first arm attached to said first telescoping member and extending rearward from said first telescoping member; a second arm attached to said second telescoping member and extending rearward from said second telescoping member; and a support attached to said base and extending forward from said base.

The universal pot holder is an article for attaching a vase, pot, or ornament to a supporting object. This universal vase or pot holder comprises: a base; a brace; a first telescoping member; a second telescoping member; a first arm attached; a second arm; and a support.

In use, the present invention would be placed adjacent to a supporting object, such as a headstone or post, with the brace placed vertically adjacent to and in contact with the supporting object, the telescoping members adjusted to approximately the dimension as the supporting object.

### BACKGROUND OF INVENTION

Plants and flowers have long been used to beautify and otherwise improve the areas in which we live and work. Placement of such plants and flowers using pots or other vases which support them is always a matter of esthetic and functional tradeoffs. These considerations often make attachment of the pots and vases to posts, headstones, or other vertically upright supporting objects highly desirable. Facilitation of such placements is an object of the present invention. Identified Inventions, which share this objective, occur in several classes.

One such class is exemplified by US Design Patent D359,629 to Korkowski. In this class the pot or vase is supported by fixed size bracket with clamping screws to affix the device to a supporting object.

A second such class is exemplified by U.S. Pat. No. 5,822,918 to Helfman, Et Al. In this class the pot or vase is supported from beneath and the mechanism is placed beneath the pot or vase and clamped over the top of the supporting object.

A third such class is exemplified by U.S. Pat. No. 3,511,461 to Clark. In this class the device is held in place by suction cups.

A fourth such class is exemplified by U.S. Pat. No. 3,386,693 to Ring. In this class the device is draped over the supporting object and held in place by elastic bands.

The fifth such class is exemplified by U.S. Pat. No. 3,310,911 to Boser, Et Al. In this class the device is held in place frictionally by applying clamping the device to the supporting object with at least one clamp at each end of the device applying clamping pressure to the front and back of the supporting object.

The present invention is adjustable for width and is held in place by clamping the supporting object between its ends, applying clamping pressure to the sides of the supporting object. In this way, the present invention depends on the dimensions of the supporting object far less than any of the above classes on inventions.

### BRIEF SUMMARY OF THE INVENTION

The universal vase holder is an article for attaching a vase, pot, or ornament to a supporting object. The universal vase holder comprises: a base; a brace attached to said base and extending downward from said base; a first telescoping member telescopically attached to said base; a second telescoping member telescopically attached to said base; a first arm attached to said first telescoping member and extending rearward from said first telescoping member; a second arm attached to said second telescoping member and extending rearward from said second telescoping member; and a support attached to said base and extending forward from said base.

In use, the present invention would be placed adjacent to a supporting object, such as a headstone or post, with the brace placed vertically adjacent to and in contact with the supporting object, the telescoping members adjusted to approximately the dimension as the supporting object.

### BRIEF DESCRIPTION OF THE DRAWINGS

FIG. 1 is a perspective view of the Universal Vase Holder.

FIG. 2 is a top view of FIG. 1.

FIG. 3 is a cut away view of another embodiment with a spring.

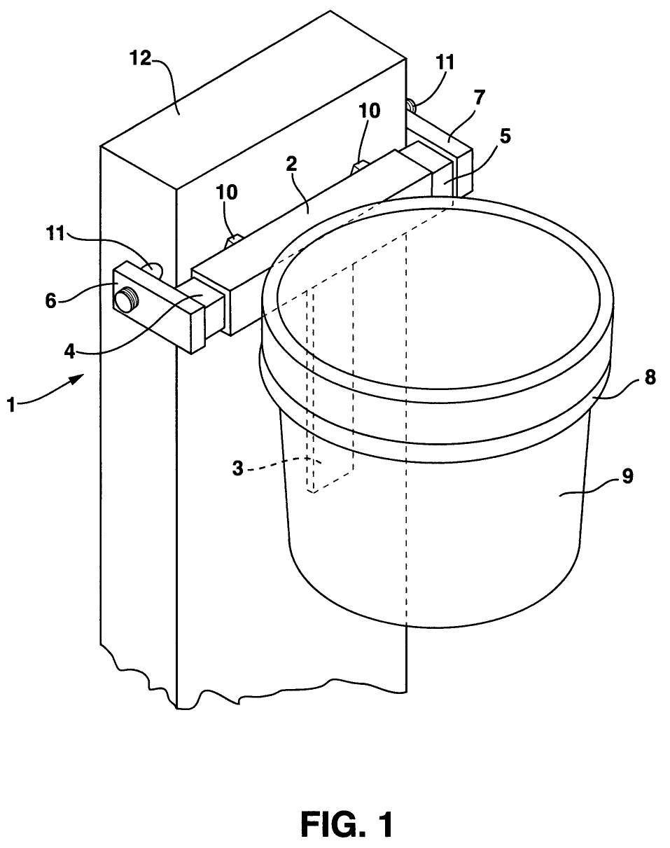

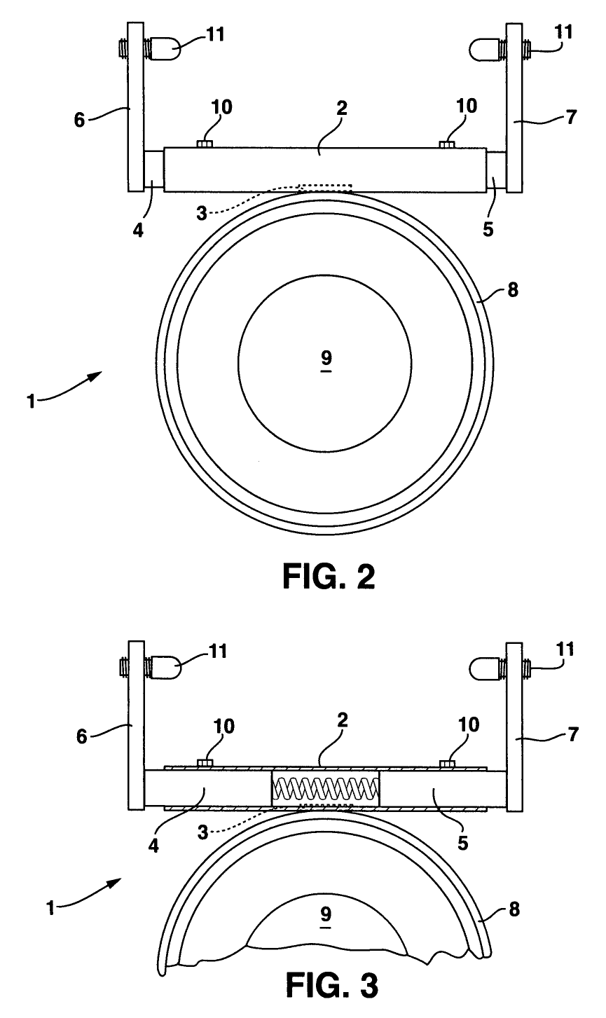

### DETAILED DESCRIPTION

The universal vase holder 1 comprises: a base 2; a brace 3 attached to said base 2 and extending downward from said base 2; a first telescoping member 4 telescopically attached to said base 2; a second telescoping member 5 telescopically attached to said base 2; a first arm 6 attached to said first telescoping member 4 and extending rearward from said first telescoping member 4; a second arm 7 attached to said second telescoping member 5 and extending rearward from said second telescoping member 5; and a support 8 attached to said base 2 and extending forward from said base 2.

The base 2 may be constructed of any material which provides sufficient strength to permit attachment of the brace 3 and support 8 to permit the support 8 to be held in an approximately horizontal attitude by the base 2. The base 2 may be hollow to provide a place for the telescoping members 4,5 to slide within. Alternatively the telescoping members 4,5 may be hollow to permit the base 2 to slide within. The base 2 illustrated has a square cross section, however the base 2 may be of any cross section which permits the telescoping and attachments described above.

The brace 3 may be of any material of sufficient strength to prevent the base 2 from rotating under the stress imposed by the support 8 and its anticipated load 9. The anticipated load depicted in the illustrations is exemplary in nature and is not a part of the present invention and may be anything the user may devise.

The telescoping members 4,5 may be of any material of sufficient strength to withstand the stress resulting from the pull of the arms 6,7 produced when the arms 6,7 are frictionally engaged with a post, headstone or other supporting object 12 to hold the universal vase holder 1 in place.

The arms 6,7 may be of a nay suitable material which can withstand the stress imposed when the arms 6,7 are frictionally engaged with a post, headstone, or other supporting object 12 and which may be attached to their respective telescoping members

The support 8 is a ring, sized to surround a vase 9 or pot 9, with said vase or pot having a larger circumference at its upper end than at its lower end. The size of the support 8 is chosen so that the vase or pot will fit within the support 8 but not be able to pass entirely through the support 8. The support 8 may be in the shape of a ring, square, hexagon, or any other shape which anticipates a vase 9 or pot 9 to be placed within the support 8. The support 8 may be of any material and of any cross section.

The vase holder 1 may further comprise: a means for locking 10 the first telescoping member 4 at a fixed degree of telescopic extension; and a means for locking 10 the second telescoping member 5 at a fixed degree of telescopic extension. This means may consist of a threaded hole and set screw or any other suitable mechanism for locking the telescoping members 4,5 in place once the telescoping members are extended to the desired length.

The Universal vase holder 1 may also further comprise an adjustment means 11 for adjusting the space between the first arm 6 and the second arm 7. This adjustment means 11 may consist of one or more threaded screw holes in each arm, each such hole fitted with a ser screw. It will be readily appreciated that any adjustment means 11 could be employed within the conception of the present invention.

In use, the present invention would be placed adjacent to a supporting object 12 such as a headstone or post, with the brace 3 placed vertically adjacent to and in contact with the supporting object 12, the telescoping members 4, 5 adjusted to approximately the dimension as the supporting object 12. In one embodiment the telescoping members 4, 5 would be drawn together to cause the arms to frictionally engage the supporting object 12 and thereby detachably attach the universal vase holder 1 to the supporting object 12. The selected vase or pot would then be placed in the support 8 for display or other purposes of the users design. Alternatively, the arms are fitted with an adjustment means 11 and the arms frictionally engaged with the supporting object 12 by the adjustment means 11.

In an alternative embodiment the telescoping members are drawn together by one or more springs, which may be internal, external, or both internal an external to the base 2, causing the arms to frictionally engage the supporting object 12.

The Universal vase holder 1 adjustment means 11 may comprise: one or more threaded holes in either the first arm 6 or the second arm 7 or both of said arms 6,7; and one set screw in each of said one or more holes. It is to be appreciated that the present invention encompasses any adjustment means 11 which causes the arms 6,7 to frictionally engage the supporting object 12 when the telescoping members 4,5 are suitably locked in position.

I claim:

1) A vase holder comprising:
a) a base;
b) a brace attached to said base and extending downward from said base;
c) a first telescoping member telescopically attached to said base;
d) a second telescoping member telescopically attached to said base;
e) a first arm attached to said first telescoping member and extending rearward from said first telescoping member;
f) a second arm attached to said second telescoping member and extending rearward from said second telescoping member; and
g) a support attached to said base and extending forward from said base.

2) The vase holder of claim 1 further comprising:
a) a means for locking the first telescoping member at a fixed degree of telescopic extension; and
b) a means for locking the second telescoping member at a fixed degree of telescopic extension.

3) The vase holder of claim 2 further comprising:
a) an adjustment means for adjusting the space between the first and second arm.

4) The vase holder of claim 3 wherein said adjustment means comprises:
a) one or more threaded holes in either the first or second arm or both of said arms; and
b) one set screw in each of said one or more holes.

5) The vase holder of claim 1 further comprising:
a) an adjustment means for adjusting the space between the first and second arm.

6) The vase holder of claim 5 wherein said adjustment means comprises:
a) one or more threaded holes in either the first or second arm or both of said arms; and
b) one set screw in each of said one or more holes.
